(19) United States
(12) Patent Application Publication
(10) Pub. No.: US 2007/0183294 A1
(43) Pub. Date: Aug. 9, 2007

(54) Objective lens driving unit and optical pickup device having the same

(75) Inventor: Kazuhiro Takahashi, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/700,811

(22) Filed: Feb. 1, 2007

(30) Foreign Application Priority Data
Feb. 7, 2006 (JP) 2006-030176

(51) Int. Cl. G11B 7/00

(52) U.S. Cl. 369/112.02; 369/44.14

(57) ABSTRACT

The movable holder of the objective lens driving unit is provided with an opening hole. An objective lens retaining portion for retaining an objective lens is disposed at the upper portion of the opening hole, while a liquid crystal element retaining portion for retaining a liquid crystal element is disposed at the lower portion of the opening hole. The movable holder is further provided with a bore that extends from the side face of the movable holder in the direction substantially perpendicular to the optical axis of the objective lens and reaches a side face 6b of the liquid crystal element retained by the liquid crystal element retaining portion so that adhesive can be injected from the bore.

This application is based on Japanese Patent Application No. 2006-030176 filed on Feb. 7, 2006, the contents of which are hereby incorporated by reference.

### BACKGROUND OF THE INVENTION

1. Field of the Invention

The present invention relates to an objective lens driving unit that is provided to an optical pickup device for projecting a light beam to an optical recording medium so that record of information or reproduction of information can be performed. In particular, the present invention relates to a structure of the objective lens driving unit that moves a liquid crystal element for correcting aberration together with an objective lens. The present invention relates also to an optical pickup device equipped with the objective lens driving unit having the devised structure.

2. Description of Related Art

Recently, optical recording media including a compact disc (hereinafter referred to as a CD) and a digital versatile disc (hereinafter referred to as a DVD) are widely spread and available. Furthermore, in order to increase recording capacity of the optical recording medium, development of high density recording on the optical recording medium and an optical pickup device supporting it have been proceeding. For example, a high density optical recording medium such as a Blu-Ray Disc (hereinafter referred to as a BD) is commercialized.

When information is recorded or reproduced on a high density optical recording medium such as a BD by using an optical pickup device, it is necessary to shorten a wavelength of a light source provided to the optical pickup device (down to 405 nm for a BD, for example) and further to increase a numerical aperture (NA) of the objective lens so that a spot size of the light beam formed on the optical recording medium by the light beam emitted from the light source.

When the light beam having such a short wavelength is used and numerical aperture of the objective lens is increased, the light beam emitted from the light source becomes apt to generate large spherical aberration because of influence of an error of thickness of a protective layer disposed on a recording layer of the optical recording medium (e.g., the thickness is 0.1 mm for a BD). As a result, there may be a problem that accuracy in recording or reproducing information by the optical pickup device is lowered.

In order to correct the aberration described above, it is common method to dispose a liquid crystal element in an optical system of the optical pickup device so that an orientation state of liquid crystal is adjustment by controlling an applied voltage. If the objective lens moves in a tracking direction for servo control in the optical pickup device equipped with a liquid crystal element for example, the center axis of the liquid crystal element is shifted from the optical axis of the objective lens. As a result, there may be a problem that coma aberration that is different from the spherical aberration described above will be generated when a voltage is applied to the liquid crystal element. For this reason, it is common to mount the objective lens and the liquid crystal element on a moving part of the objective lens driving unit provided to the optical pickup device so that both of them are moved at the same time.

However, also in the case described above, if the center axis of the liquid crystal element is shifted from the optical axis of the objective lens due to insufficient adjustment in the assembling process, the coma aberration is generated. Therefore, it is necessary to adjust the relative position between the liquid crystal element and the objective lens precisely in the assembling process. JP-A-2002-237077 describes a liquid crystal element as a technique that enables adjustment of the relative position between the liquid crystal element and the objective lens with high precision. This liquid crystal element that is an aberration correcting element includes a plurality of position markers for position adjustment on one of electrode layers of the liquid crystal element.

In addition, JP-A-2005-71457 describes an objective lens driving actuator of an optical pickup having positioning markers provided both to the liquid crystal element and to objective lens. According to these structures, the center axis of the liquid crystal element for reducing spherical aberration and the optical axis of the objective lens can be matched with each other. As a result, quality of light spot projected to the recording surface of the optical disc becomes stable in a good state so that a high density optical disc device can be written and read with stability, according to description in the document.

However, in the structure described in JP-A-2002-237077 or JP-A-2005-71457, there is a problem that relative position between the center axis of the liquid crystal element and the optical axis of the objective lens cannot be adjusted precisely because of variation of machining accuracy of the position markers with respect to the center axis of the liquid crystal element and the optical axis of the objective lens. In addition, there is also a problem that precise positioning cannot be performed sufficiently because that a magnification of a CCD (a slid-state image sensing device) camera cannot be set to a large value when the CCD camera is used for viewing the position markers for adjusting relative position between the liquid crystal element and the objective lens, since it is necessary to view a plurality of position markers at the same time.

In addition, there is also a problem that attachment work of the liquid crystal element to a movable holder is difficult because that liquid crystal element can hardly seen by the CCD camera when a highly transparent electrodes are used for improving quality in reading information. In addition, there is also a problem that the liquid crystal element is shifted from the position before being adhered due to contraction of adhesive if the liquid crystal element is fixed by using the adhesive.

### SUMMARY OF THE INVENTION

In view of the above described problems it is an object of the present invention to provide an objective lens driving unit equipped with a liquid crystal element for correcting aberration that enables precise adjustment of relative position between the optical axis of the objective lens and the center axis of the liquid crystal element. Another object of the present invention is to provide an optical pickup device that enables obtaining high reliability of quality in recording and reproducing information, being equipped with the objective lens driving unit that can adjust relative position between the optical axis of the objective lens and the center axis of the liquid crystal element.

To attain the above described first object, an objective lens driving unit for moving an objective lens and a liquid crystal element in accordance with one aspect of the present invention includes a movable holder having: the objective lens for condensing a light beam emitted from a light source on a recording surface on an optical recording medium; the liquid crystal element for correcting aberration disposed between the light source and the objective lens so as to face the objective lens; an opening hole; an objective lens retaining portion disposed at one end of the opening hole for retaining the objective lens; and a liquid crystal element retaining portion disposed at the other end of the opening hole for retaining the liquid crystal element. And the objective lens driving unit is characterized by a structure in which the movable holder is provided with an injection hole for injecting adhesive for fixing the liquid crystal element to the movable holder.

Moreover, in the objective lens driving unit of the present invention having the structure described above, the injection hole is provided to a side face of the movable holder.

Moreover, in the objective lens driving unit of the present invention having the structure described above, the injection hole is a bore extending from the side face of the movable holder in the direction substantially perpendicular to the optical axis of the objective lens and reaches the side face of the liquid crystal element.

Moreover, the present invention provides an optical pickup device equipped with the objective lens driving unit having the structure described above.

To attain the above described second object, an optical pickup device in accordance with another aspect of the present invention is equipped with a light source and an objective lens driving unit for moving an objective lens and a liquid crystal element, and the objective lens driving unit includes a movable holder having: the objective lens for condensing a light beam emitted from a light source on a recording surface on an optical recording medium; the liquid crystal element for correcting aberration disposed between the light source and the objective lens so as to face the objective lens; an opening hole; an objective lens retaining portion disposed at one end of the opening hole for retaining the objective lens; and a liquid crystal element retaining portion disposed at the other end of the opening hole for retaining the liquid crystal element. And the optical pickup device is characterized by a structure in which the movable holder is provided with an injection hole provided to a side face of the movable holder for injecting adhesive for fixing the liquid crystal element to the movable holder, injection hole being a bore extending from the side face of the movable holder in the direction substantially perpendicular to the optical axis of the objective lens and reaches the side face of the liquid crystal element.

According to the first structure of the present invention, the injection hole for injecting adhesive for fixing the liquid crystal element is provided to the movable holder. Therefore, when the optical axis of the objective lens and the center axis of the liquid crystal element are aligned, it is possible to project a light beam to the objective lens and the liquid crystal element for adjustment, to search a position where the coma aberration becomes minimum while moving the liquid crystal element, and to inject adhesive from the injection hole so as to fix the liquid crystal element when a optimal position is found. Therefore, it is unnecessary to perform adjustment of relative position between the optical axis of the objective lens and the center axis of the liquid crystal element while viewing the liquid crystal element as well as a marker for positioning provided to the liquid crystal element, and the positioning can be performed easily and precisely. In addition, since the positioning can be performed while measuring a position where the coma aberration becomes minimum as described above, it is possible to measure the coma aberration also during a period while the adhesive is being cured so that fine adjustment of a position of the liquid crystal element can be performed before the adhesive is cured completely. Thus, it is possible to relieve a shift of position due to contraction of the adhesive.

In addition, according to the second structure of the present invention, in the objective lens driving unit having the first structure described above, it is possible to dispose the injection hole at a position that the liquid crystal element can be fixed easily, because the disposed injection hole is provided to the side face of the movable holder.

In addition, according to the third structure of the present invention, in the objective lens driving unit having the second structure described above, it is possible to form the injection hole easily. In addition, UV cure adhesive for fixing the liquid crystal element to the movable holder can be cured by projecting ultraviolet rays into the injection hole. Therefore, the work of fixing the liquid crystal element at the correct position can be performed easily.

In addition, according to the fourth structure of the present invention, the optical pickup device equipped with the objective lens driving unit having any one of the first to the third structures described above can adjust relative position precisely between the optical axis of the objective lens and the center axis of the liquid crystal element disposed for aberration correction. Therefore, it is possible to maintain high performance of the optical pickup in recording and reproducing information, so that reliability of the device can be improved.

In addition, according to the fifth structure of the present invention, the movable holder is provided with an injection hole for injecting adhesive for fixing the liquid crystal element. Therefore, when the optical axis of the objective lens and the center axis of the liquid crystal element are aligned, it is possible to project a light beam to the objective lens and the liquid crystal element for adjustment, to search a position where the coma aberration becomes minimum while moving the liquid crystal element, and to inject adhesive from the injection hole so as to fix the liquid crystal element when a optimal position is found. Therefore, it is unnecessary to perform adjustment of relative position between the optical axis of the objective lens and the center axis of the liquid crystal element while viewing the liquid crystal element as well as a marker for positioning provided to the liquid crystal element, and the positioning can be performed easily and precisely.

In addition, since the positioning can be performed while measuring a position where the coma aberration becomes minimum as described above, it is possible to measure the coma aberration also during a period while the adhesive is being cured so that fine adjustment of a position of the liquid crystal element can be performed before the adhesive is cured completely. Thus, it is possible to relieve a shift of position due to contraction of the adhesive. In addition, since the injection hole is provided to the side face of the movable holder and the injection hole is a bore extending in the direction substantially perpendicular to the optical axis of the objective lens, the injection hole can be formed easily. Furthermore, the liquid crystal element can be fixed easily. Therefore, positioning between the optical axis of the objective lens and the center axis of the liquid crystal element that is disposed for aberration correction can be performed precisely, so that the optical pickup can record and reproduce information correctly. Thus, the optical pickup device of the present invention can obtain high reliability.

### BRIEF DESCRIPTION OF THE DRAWINGS

FIG. 1 is a schematic diagram to show a structure of an optical system of an optical pickup device according to the present embodiment.

FIG. 2 is a schematic top view to show a structure of an objective lens driving unit provided to the optical pickup device of the present embodiment.

FIG. 3 is a schematic side view to show a structure of the objective lens driving unit provided to the optical pickup device of the present embodiment.

FIG. 4A is a cross sectional view when cut along the line A-A in FIG. 3.

FIG. 4B is a cross sectional view when cut along the line B-B in FIG. 3.

FIG. 5 is a cross sectional view when cut along the line C-C in FIG. 2, to show a structure of a periphery of an opening hole of a movable holder.

FIG. 6 is a flowchart of a process for alignment between an objective lens and a liquid crystal element in the objective lens driving unit according to the present embodiment.

### DETAILED DESCRIPTION OF THE PREFERRED EMBODIMENTS

Now, an embodiment of the present invention will be described with reference to the attached drawings. At this point the embodiment described below is merely an example, and the present invention is not limited to this embodiment.

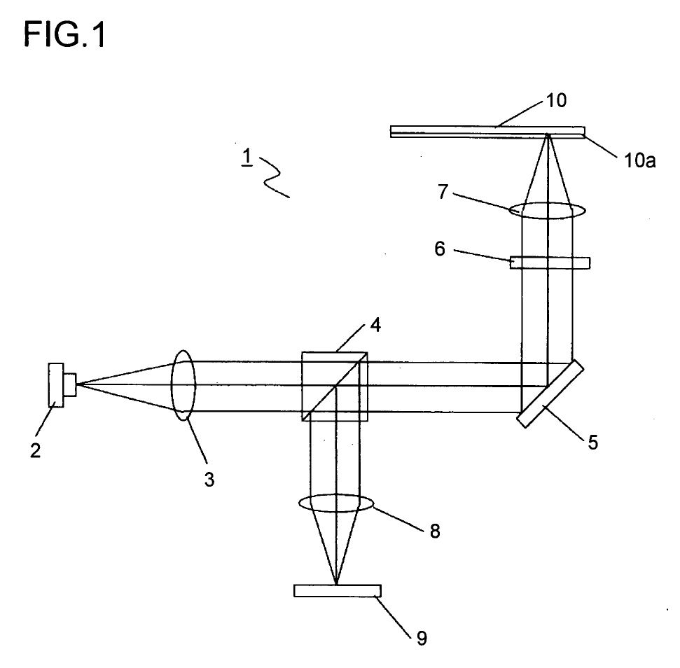

FIG. 1 is a schematic diagram to show a structure of an optical system of an optical pickup device equipped with an objective lens driving unit of the present invention. In FIG. 1, numeral 1 denotes the optical pickup device that projects a light beam to an optical recording medium 10 such as, for example, a CD or a DVD and receives a reflection light from it for reading information recorded on a recording surface 10a of the optical recording medium 10. It also projects a light beam to the optical recording medium 10 for writing information on the recording surface 10a. The optical system of the optical pickup device 1 is equipped with a light source 2, a collimator lens 3, a beam splitter 4, an upstand mirror 5, a liquid crystal element 6, an objective lens 7, a condenser lens 8, and a photo detector 9, for example. Hereinafter, detail of each optical element will be described.

The light source 2 is made up of a semiconductor laser. If the optical pickup device 1 is an optical pickup device for a BD for example, the light source 2 emits a laser beam having a wavelength of 405 nm, for example. In addition, if the optical pickup device 1 is for a CD or for a DVD, the light source 2 emits a laser beam having a wavelength of 780 nm or 650 nm, for example. Although the light source 2 has a structure for emitting a laser beam having a single wavelength in the present embodiment, the present invention is not limited to this structure. For example, it is possible that the light source 2 is a light source having two wavelengths in one package so that the optical pickup device can record and reproduce information on a BD and a DVD. In addition, it is possible to add a light source for a CD so that the optical pickup device can record and reproduce information on three types of discs including a CD, a DVD and a BD.

The collimator lens 3 is a lens for converting the laser beam emitted from the light source 2 into parallel rays. The term “parallel rays” means light having in which all the laser rays emitted from the light source 2 have optical paths that are substantially parallel with the optical axis. The parallel rays that passed through the collimator lens 3 are sent to the beam splitter 4.

The beam splitter 4 works as a separation element for separating a laser beam. It permits the laser beam that passed through the collimator lens 3 to pass through and leads the laser beam to the optical recording medium 10, while it reflects the laser beam that was reflected by the optical recording medium 10 and leads the laser beam to the photo detector 9. The laser beam that passed through the beam splitter 4 is sent to the upstand mirror 5.

The upstand mirror 5 is tilted from the optical axis of the light beam emitted from the light source 2 by 45 degrees for example, so it reflects the laser beam that passed through the beam splitter 4 and leads the laser beam to the liquid crystal element 6.

The liquid crystal element 6 includes liquid crystal and two transparent electrodes sandwiching the liquid crystal (both of them are not shown). One of the transparent electrodes forms a common electrode, while the other is divided into a plurality of electrodes that are formed in a concentric manner. Then, by controlling a voltage applied to each of the divided electrodes, a state of orientation in the liquid crystal is adjusted. Thus, a phase of the laser beam that passes through the liquid crystal element can be controlled. As a result, it is possible to correct spherical aberration that is generated due to an error of thickness of the protective layer that protects the recording surface 10a of the optical recording medium 10. The laser beam that passed through the liquid crystal element 6 is sent to the objective lens 7. At this point the structure of the liquid crystal element 6 can be modified within the scope of the present invention.

The objective lens 7 condenses the laser beam that passed through the liquid crystal element 6 on the recording surface 10a of the optical recording medium 10. A numerical aperture (NA) of the objective lens 7 is set to a value of 0.85 in the case where the optical pickup device 1 is for a BD, for example. In addition, if the optical pickup device 1 is for a CD or for a DVD for example, the numerical aperture (NA) is set to a value of 0.5 or 0.65. At this point the liquid crystal element 6 and the objective lens 7 are mounted on the objective lens driving unit that will be described later, so that they can be moved in a predetermined direction.

The laser beam reflected by the optical recording medium 10 passes through the objective lens 7 and the liquid crystal element 6 and is reflected by the upstand mirror 5. After that, it is reflected by the beam splitter 4 and is condensed by the condenser lens 8, and it reaches a light receiving portion (not shown) of the photo detector 9.

The photo detector 9 converts the received light signal into an electric signal, which is output to an RF amplifier or the like, for example. Then, this electric signal is used as a reproduction signal of data recorded on the recording surface 10a and further as a servo signal for performing focus control and tracking control. In addition, the obtained electric signal is used also as a signal for correcting aberration so that this signal determines a voltage that is applied to the transparent electrode of the liquid crystal element 7.

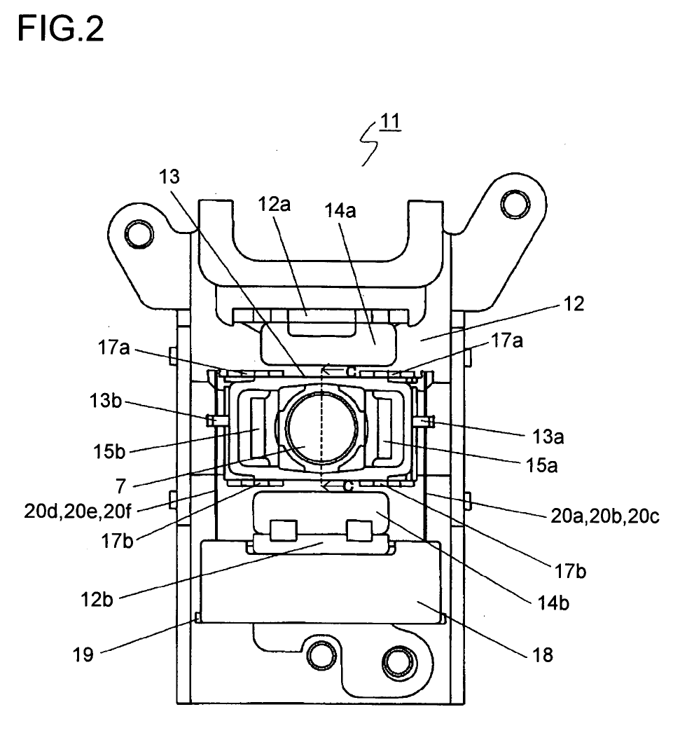

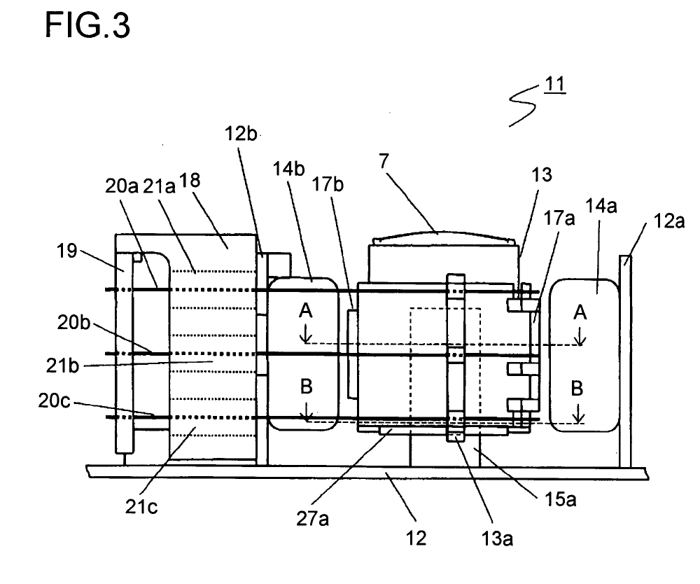

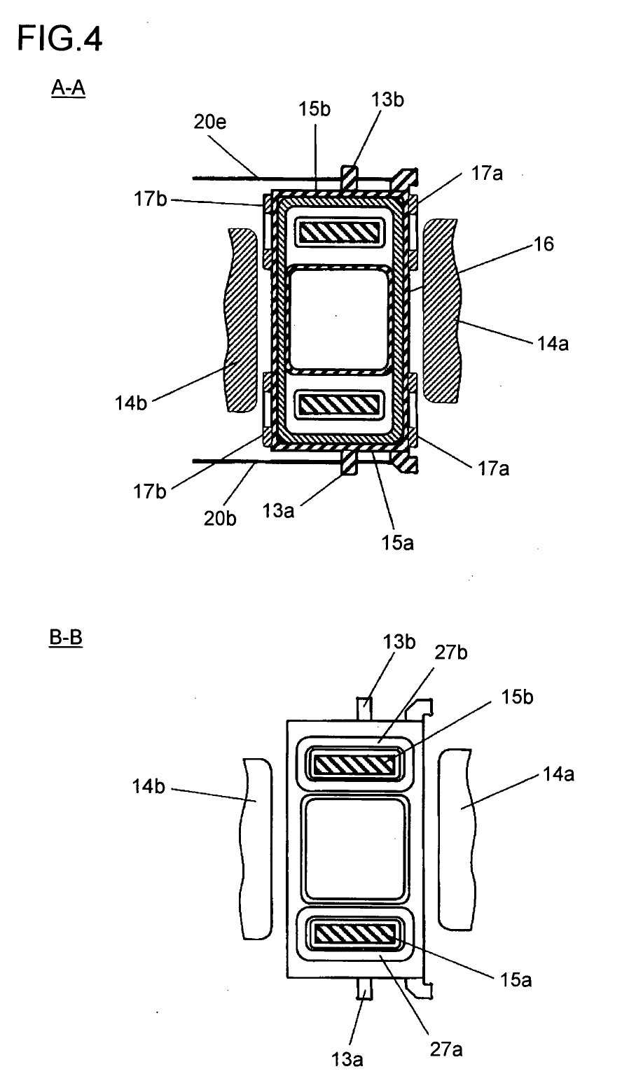

Next, detail of an objective lens driving unit 11 provided to the optical pickup device 1 of the present embodiment will be describe with reference to FIGS. 2 to 4. FIG. 2 is a schematic top view to show a structure of the objective lens driving unit 11 according to the present embodiment, FIG. 3 is a schematic side view to show a structure of the objective lens driving unit 11 according to the present embodiment, FIG. 4A is a cross sectional view when cut along the line A-A in FIG. 3 and FIG. 4B is a cross sectional view when cut along the line B-B in FIG. 3.

The objective lens driving unit 11 is mainly made up of a metallic base member 12 having ferromagnetism and a movable holder 13 that is a resin molded part. A through hole (not shown) for the laser beam from the light source 2 (see FIG. 1) to pass through is formed substantially, at the center of the base member 12, and a movable holder 13 that will be described in detail later is arranged there. In addition, a pair of permanent magnets 14a and 14b are arranged so as to face each other via the movable holder 13 between them at a predetermined gap on the base member 12. Each of the permanent magnets 14a and 14b is fixed to the base member 12 in an integrated manner when outer faces of the permanent magnets 14a and 14b are respectively attracted magnetically and fixed to the protrusions 12a and 12b that are shaped to bend from the base member 12.

In addition, a pair of yokes 15a and 15b are provided to the base member 12 between the permanent magnets 14a and 14b so that they face each other in the direction perpendicular to the facing direction of the permanent magnets 14a and 14b. These yokes 15a and 15b are shaped to bend from the base member 12. At this point the yokes 15a and 15b have a role of drawing magnetic fluxes from the permanent magnets 14a and 14b effectively so that high density magnetic fluxes are given mainly to a focus coil 16, tracking coils 17a and 17b, and tilting coils 27a and 27b disposed between them, which will be described later. Thus, drive efficiency of the movable holder 13 can be improved.

The movable holder 13 includes the objective lens 7 disposed at an objective lens retaining portion that is formed at the upper middle portion of it and the liquid crystal element 6 (see FIG. 1) disposed at a liquid crystal element retaining portion that is formed at the lower middle portion of it (both portions will be described later). The yokes 15a and 15b penetrate from the left to the right sandwiching the objective lens 7 and the liquid crystal element 6. The focus coil 16 is arranged so as to surround the optical axis of the objective lens 7 inside the side walls of the movable holder 13 and is fixed to the movable holder 13 by adhesive or the like. In addition, the tracking coils 17a and 17b are fixed by adhesives or the like to the outer faces of the both side walls of the movable holder 13 facing the permanent magnets 14a and 14b. A pair of the tracking coils 17a and 17b is formed on the left and on the right each so as to face the yokes 15a and 15b, and they are connected in series as a whole. In addition, the tilting coils 27a and 27b are fixed by adhesive or the like to the lower portion of the focus coil 16 so as to surround the yokes 15a and 15b. The tilting coils 27a and 27b are also connected in series as a whole.

In addition, a gel holder 18 that is a resin molding component made of polycarbonate or the like is fixed to the outer face side of the protrusion 12b to which one of the permanent magnet 14b is fixed magnetically on the base member 12. Further, a circuit board 19 is disposed so as to neighbor the outside of the gel holder 18. One of ends of each conductive wire 20a, 20b, 20c, 20d, 20e or 20f is soldered to the circuit board 19 at the right and left sides at three positions each separated in the vertical direction. Each of these six wires 20a, 20b, 20c, 20d, 20e and 20f passes through each of through holes 21a, 21b, 21c, 21d, 21e and 21f formed in the gel holder 18 at positions corresponding to the connection to circuit board 19, i.e., at the right and left sides and at three positions each separated in the vertical direction.

In addition, the wires 20a-20f are bonded to spines 13a and 13b protruding from the right and left sides of the movable holder 13 by adhesive or the like. Thus, the movable holder 13 is supported by the wires 20a-20f in a shakable manner with respect to the base member 12. Then, the other ends of the wires 20a and 20d at the upper side are soldered to the focus coil 16, the other ends of the wires 20b and 20e at the middle are soldered to the tracking coils 17a and 17b, and the other ends of the wires 20c and 20f at the lower side are soldered to the tilting coils 27a and 27b.

Each of the through holes 21a-21f of the gel holder 18, which the wires 20a-20f pass through, is filled with a gel material whose main ingredient is silicone. The gel material is formed by injecting low-viscosity gel material (sol) into the through holes 21a-21f of the gel holder 18 and by irradiating it with ultraviolet rays a predetermined period of time so that the material is cured into a gel state.

When current is supplied to the focus coil 16, the tracking coils 17a and 17b, and the tilting coils 27a and 27b from the circuit board 19 via the wires 20a-20f in the objective lens driving unit 11 having the structure described above, an electromagnetic force is generated between each of these coils 16, 17a, 17b, 27a and 27b and each of the permanent magnets 14a and 14b. As a result, the movable holder 13 is driven so that focus adjustment, tracking adjustment and tilt adjustment of the objective lens 7 can be performed. At this point a vibration generated in each of the wires 20a-20f when the movable holder 13 is driven is attenuated and suppressed by the gel material in the through holes 21a-21f of the gel holder 18 with damping. In addition, since the objective lens 7 and the liquid crystal element 6 are attached to the movable holder 13 as described above, the liquid crystal element 6 moves together with the objective lens 7.

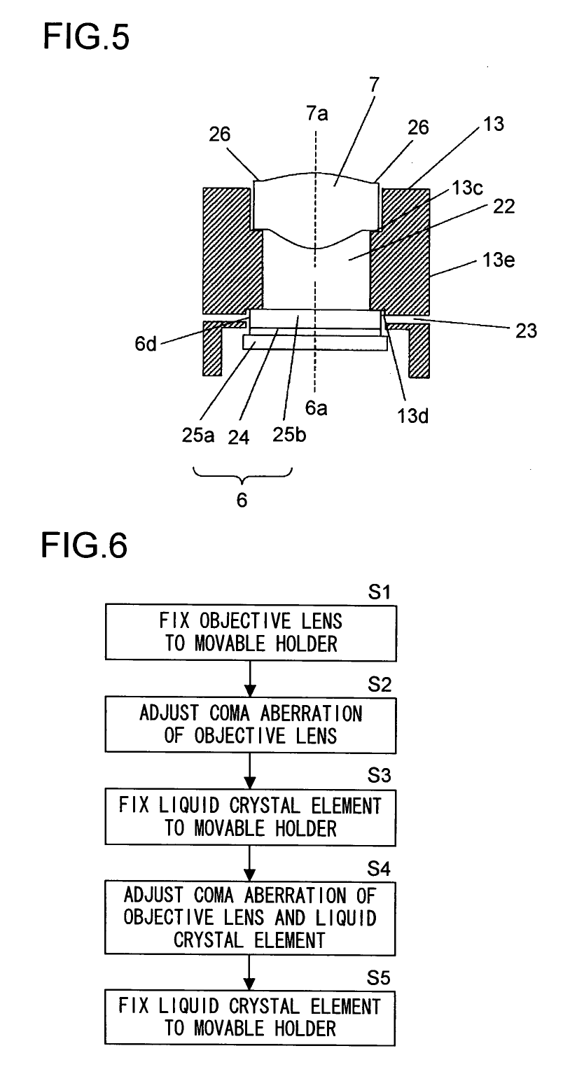

Next, a structure of a periphery of an opening hole 22 provided to the movable holder 13 of the objective lens driving unit 11 will be described in detail with reference to FIG. 5. FIG. 5 is a cross section when cut along the line C-C in FIG. 2. At this point the focus coil 16 (see FIG. 4) is not shown in FIG. 5 for convenience.

The opening hole 22 is formed at the center of the movable holder 13, and an objective lens retaining portion 13c for retaining the objective lens 7 is provided to the upper portion of the opening hole 22. At the lower portion of the opening hole 22, a liquid crystal element retaining portion 13d is provided for retaining the liquid crystal element 6 that is made up of liquid crystal 24 and transparent electrodes 25a and 25b sandwiching the liquid crystal 24. The objective lens 7 and the liquid crystal element 6 are respectively retained by the objective lens retaining portion 13c and the liquid crystal element retaining portion 13d so that an optical axis 7a of the objective lens 7 matches a center axis 6a of the liquid crystal element 6.

If the optical axis 7a of the objective lens 7 and the center axis 6a of the liquid crystal element 6 do not match each other, a problem such as an increase of jitter may occur due to generation of coma aberration as described above. Therefore, when the objective lens 7 and the liquid crystal element 6 are disposed at the objective lens retaining portion 13c and the liquid crystal element retaining portion 13d respectively, it is very important to make alignment between them.

In order to perform the alignment precisely, the movable holder 13 of the objective lens driving unit 11 according to the present embodiment is provided with two bores 23 as shown in FIG. 5. Each of the bores 23 extends from the side face 13e of the movable holder 13 in the direction substantially perpendicular to the optical axis 7a of the objective lens 7 and reaches a side face 6b of the liquid crystal element 6, so that the adhesive can be injected through the bore 23. Hereinafter, this bore 23 is referred to as an injection hole 23.

At this point there is no limitation to the shape of the injection hole 23 and therefore its cross sectional shape can be circular or like a slit (rectangular) or the like. In addition, the number of the injection holes 23 also has no limitation as long as the liquid crystal element 6 can be fixed by injecting adhesive through the injection holes 23. However, providing the plurality of injection holes 23 is more preferable than providing a single injection hole 23 for the purpose of fixing the liquid crystal element 6 securely.

Next, a concrete procedure of adjusting so that the optical axis 7a of the objective lens 7 and the center axis 6a of the liquid crystal element 6 match each other in the objective lens driving unit 12 by using the injection holes 23 for injecting the adhesive will be described with reference to FIG. 5 and a flowchart of adjustment shown in FIG. 6.

First, the objective lens 7 is placed on the objective lens retaining portion 13c provided to the upper portion of the movable holder 13 so that the optical axis 7a of the objective lens 7 becomes in the vertical direction, and they are fixed to each other by using UV cure adhesive or the like (Step S1). Then, the movable holder 13 to which the objective lens 7 is mounted is fixed as a whole to a jig (not shown) by using the edge surface 26 of the objective lens 7 as a contact surface. Then, a laser beam from the reference light source (not shown) is projected into the opening hole 22 of the movable holder 13 at the lower portion, and coma aberration of the laser beam that pass through the objective lens 7 is measured with a spot adjuster or a interferometer (not shown). Then, gradient of the jig to which the movable holder 13 is attached is adjusted so that the measured value of the coma aberration becomes a minimum value (substantially zero) (Step S2).

Furthermore, in the present embodiment, the reference light is provide separately for aligning the objective lens 7 and the liquid crystal element 6, and the laser beam emitted from the reference light source is converted by the collimator lens into parallel rays, which enters the objective lens 7. However, it is possible to adopt another structure, in which divergent light enters the objective lens without using a collimator lens, so that alignment of the objective lens 7 and the liquid crystal element 6 is performed, for example.

After coma aberration of the objective lens 7 is adjusted, the liquid crystal element 6 is arranged at the liquid crystal element retaining portion 13d that is provided to the lower portion of the movable holder 13 so that the laser beam emitted from the reference light source enters the liquid crystal element 6 perpendicularly. Then, the liquid crystal element 6 is fixed temporarily with a jig (not shown) (Step S3).

After that, coma aberration of the laser beam that is emitted from the reference light source and passes through the liquid crystal element 6 and the objective lens 7 in this order is measured with the spot adjuster or the interferometer. Then, the liquid crystal element 6 is moved in the direction perpendicular to the paper (X direction) and in the horizontal direction (Y direction) in FIG. 5 so that the optical axis 7a of the objective lens 7 matches the center axis 6a of the liquid crystal element 6 and that coma aberration becomes minimum (substantially zero) (Step S4). At this point the jig for fixing the liquid crystal element 6 is attached to an X-Y stage for example so that the jig can be moved in the X direction and in the Y direction.

When the coma aberration becomes a minimum value in the step S4, UV cure adhesive for example is injected from the injection hole 23 that is provided to the movable holder 13. Then, ultraviolet rays are projected from the injection hole 23 so that the adhesive is cured. Thus, the liquid crystal element 6 is fixed in the state where the center axis 6a of the liquid crystal element 6 matches the optical axis 7a of the objective lens 7 (Step S5).

As described above, since the injection holes 23 for injecting adhesive easily from the outside are provided to the movable holder 13, it is not necessary to adjusting the position of the liquid crystal element 6 by viewing with a CCD camera or the like when it is adhered unlike the conventional structure. Thus, the objective lens 7 and the liquid crystal element 6 arranged in the objective lens driving unit 11 can be aligned easily and precisely. In addition, if UV cure adhesive is used for fixing the liquid crystal element 6, it is necessary to secure time from irradiation to ultraviolet rays until the adhesive is cured completely. Since coma aberration is measured also during the irradiation to the ultraviolet rays, fine adjustment of a position of the liquid crystal element 6 can be performed in accordance with a variation of the measurement value of the coma aberration. Thus, it is possible to relieve a shift of axis due to contraction of the adhesive.

Although the injection hole 23 provided to the movable holder 13 has a shape extending from the side face 13e of the movable holder 13 in the direction substantially perpendicular to the optical axis 7a of the objective lens 7 in the embodiment described above, the present invention is not limited to this structure. It can be modified in the scope of the present invention. For example, it is possible to adopt a structure in which the injection hole 23 is formed in an L-shape so that adhesive is injected from the top face of the liquid crystal element 6 for fixing it. Alternatively, it is possible to adopt a structure in which an injection hole that extends from the top face of the movable holder 13 to the liquid crystal element 6 is formed.

Although the objective lens driving unit 11 of the present embodiment has a so-called wire supporting actuator in which the movable holder 13 provided with the objective lens 7 and the liquid crystal element 6 is supported by a plurality of wires (metal wires) so that it can swing with respect to the base member 12, the present invention is not limited to this structure. For example, the present invention can be applied to an objective lens driving unit having a biaxial actuator of an axial sliding type or the like.

The present invention is applied to an objective lens driving unit for moving an objective lens and a liquid crystal element. The objective lens driving unit for moving an objective lens and a liquid crystal element, includes a movable holder having: the objective lens for condensing a light beam emitted from a light source on a recording surface on an optical recording medium; the liquid crystal element for correcting aberration disposed between the light source and the objective lens so as to face the objective lens; an opening hole; an objective lens retaining portion disposed at one end of the opening hole for retaining the objective lens; and a liquid crystal element retaining portion disposed at the other end of the opening hole for retaining the liquid crystal element, and it is characterized by a structure in which the movable holder is provided with an injection hole for injecting adhesive for fixing the liquid crystal element to the movable holder.

Therefore, when the optical axis of the objective lens and the center axis of the liquid crystal element are aligned, it is possible to project a light beam to the objective lens and the liquid crystal element for adjustment, to search a position where the coma aberration becomes minimum while moving the liquid crystal element, and to inject adhesive from the injection hole so as to fix the liquid crystal element when a optimal position is found. In other words, when positioning the liquid crystal element to be aligned to the objective lens, it is unnecessary to perform adjustment of relative position between the optical axis of the objective lens and the center axis of the liquid crystal element while viewing the liquid crystal element as well as a marker for positioning provided to the liquid crystal element, and the positioning can be performed easily and precisely.

In addition, since the injection hole is provided to a side face of the movable holder, it is possible to dispose the injection hole at a position that the liquid crystal element can be fixed easily.

In addition, since the injection hole is a bore extending from the side face of the movable holder in the direction substantially perpendicular to the optical axis of the objective lens and reaches the side face of the liquid crystal element, the liquid crystal element can be fixed easily by using UV cure adhesive. Thus, the liquid crystal element can be aligned with the objective lens more precisely.

In addition, the optical pickup device equipped with the objective lens driving unit described above can adjust relative position precisely between the optical axis of the objective lens and the center axis of the liquid crystal element that is disposed for aberration correction. Therefore, it is possible to improve performance of the optical pickup in recording and reproducing information.

What is claimed is:

1. An objective lens driving unit for moving an objective lens and a liquid crystal element, comprising a movable holder having:
the objective lens for condensing a light beam emitted from a light source on a recording surface on an optical recording medium;
the liquid crystal element for correcting aberration disposed between the light source and the objective lens so as to face the objective lens;
an opening hole;
an objective lens retaining portion disposed at one end of the opening hole for retaining the objective lens; and
a liquid crystal element retaining portion disposed at the other end of the opening hole for retaining the liquid crystal element, wherein
the movable holder is provided with an injection hole for injecting adhesive for fixing the liquid crystal element to the movable holder.

2. The objective lens driving unit according to claim 1, wherein the injection hole is provided to a side face of the movable holder.

3. The objective lens driving unit according to claim 2, wherein the injection hole is a bore extending from the side face of the movable holder in the direction substantially perpendicular to the optical axis of the objective lens and reaches the side face of the liquid crystal element.

4. The optical pickup device equipped with the objective lens driving unit according to claims 1.

5. An optical pickup device equipped with a light source and an objective lens driving unit for moving an objective lens and a liquid crystal element, the objective lens driving unit comprising a movable holder having:
the objective lens for condensing a light beam emitted from a light source on a recording surface on an optical recording medium;
the liquid crystal element for correcting aberration disposed between the light source and the objective lens so as to face the objective lens;
an opening hole;
an objective lens retaining portion disposed at one end of the opening hole for retaining the objective lens; and
a liquid crystal element retaining portion disposed at the other end of the opening hole for retaining the liquid crystal element, wherein
the movable holder is provided with an injection hole provided to a side face of the movable holder for injecting adhesive for fixing the liquid crystal element to the movable holder, injection hole being a bore extending from the side face of the movable holder in the direction substantially perpendicular to the optical axis of the objective lens and reaches the side face of the liquid crystal element.
